(19) United States
(12) Patent Application Publication
(10) Pub. No.: US 2025/0292722 A1
(43) Pub. Date: Sep. 18, 2025

(54) ARCHITECTURE AND METHOD FOR DRIVING SUPERDENSE AMPLITUDE MODULATED MICRO-LED ARRAYS

(71) Applicant: GOOGLE LLC, Mountain View, CA (US)

(72) Inventors: Thomas Charisoulis, San Carlos, CA (US); Ya Chi Lee, Mountain View, CA (US)

(21) Appl. No.: 18/861,452

(22) PCT Filed: May 10, 2023
(86) PCT No.: PCT/US2023/021642

§ 371 Date: Oct. 29, 2024

Related U.S. Application Data
(60) Provisional application No. 63/341,582, filed on May 13, 2022.

(51) Int. Cl. G09G 3/32

(52) U.S. Cl. CPC G09G 3/32; G09G 2300/0842; G09G 2300/0861; G09G 2310/08; G09G 2320/0233; G09G 2320/0242; G09G 2320/041

(57) ABSTRACT

The body node (gate terminal) of a drive transistor of a pixel drive circuit of a micro-light emitting diode (μLED) of a display is used to modulate an amplitude and a pulse width of a current supplied to the μLED by the pixel drive circuit. In some embodiments, the body node of the drive transistor of the μLED pixel drive circuit is used to modify the current through the drive transistor to apply a demura compensation. Applying demura compensation via the body node of the drive transistor of the pixel drive circuit saves power, memory, and dynamic range.

### BACKGROUND

Display panels typically include arrays of large numbers of (e.g., up to one million or more) light emitting diodes (LEDs) or micro-light emitting diodes (micro-LEDs or μLEDs) that form pixels of a display. Even if 99% of the μLEDs can be expected to operate according to specified parameters, the remaining 1% can be expected to operate outside the specified parameters. Thus, for a display panel including an array of one million μLEDs, approximately 10,000 μLEDs can be expected to function outside the specified parameters and, at a given driving current, to produce light having a different intensity than the rest of the μLEDs of the display when driven at the same current. The light having a different intensity will appear to a user as noise.

To ensure uniformity of light emission from the LEDs of a display panel, after the fabrication process, a “demura” process takes place during what is called “TO calibration.” In the demura process, the display panel is driven and a camera takes a number of pictures at different Gray Levels (GLs), Display Brightness Values (DBVs) and, in some cases, temperatures. Using the captured images, each pixel's brightness is derived and compared to a Gamma curve as well as primaries of the color space and the error in color and luminance is calculated. This error is then used to estimate gain and offset values that are stored in a look-up table for each pixel. These gains and offsets are then used to adjust the data “on the fly” and send the corrected values to the display in order to make it look more uniform. In this way, variations in the fabrication process and random systematic error are minimized to make display illumination and color uniform.

### BRIEF SUMMARY OF EMBODIMENTS

In an embodiment, a method includes controlling a gate terminal of a drive transistor of a pixel drive circuit of a micro-light emitting diode (μLED) of a display to modulate an amplitude and a pulse width of a current supplied to the μLED by the pixel drive circuit. In some embodiments, controlling the gate terminal includes applying a demura compensation to adjust an amount of light emitted by the μLED.

In some embodiments, a value of the demura compensation is based on at least one of a temperature of the pixel drive circuit and a desired brightness of the μLED. The demura compensation value is stored at a capacitor of the pixel drive circuit in some embodiments. In other embodiments, the demura compensation value is stored at a transistor of the pixel drive circuit. In yet other embodiments, both a pixel value and the demura compensation value are stored at a dual gate transistor of the pixel drive circuit. The value of the demura compensation is stored while the display is off in some embodiments.

In another embodiment, a pixel drive circuit includes a drive transistor including a gate terminal configured to control a gate voltage of the drive transistor to adjust an amplitude and a pulse width of a current supplied to a micro-LED (μLED) of a display. In some embodiments, the drive transistor is configured to apply a demura compensation to adjust an amount of light emitted by the μLED.

The value of the demura compensation is based on at least one of a temperature of the pixel circuit and a desired brightness of the μLED in some embodiments. In some embodiments, the pixel drive circuit includes a capacitor to store the value of the demura compensation. In other embodiments, the pixel drive circuit includes a transistor to store the value of the demura compensation. In yet other embodiments, the pixel drive circuit includes a dual gate transistor to store both a pixel value and the value of the demura compensation. In some embodiments, the value of the demura compensation is stored while the display is off.

In another embodiment, a display includes an array of μLEDs and a pixel drive circuit configured to drive each μLED of the array. Each pixel drive circuit includes a drive transistor including a gate terminal configured to control a gate voltage of the drive transistor to adjust an amplitude and a pulse width of a current supplied to the μLED.

In some embodiments, the drive transistor is configured to apply a demura compensation to adjust an amount of light emitted by the μLED. In some embodiments, a value of the demura compensation is based on at least one of a temperature of the pixel circuit and a desired brightness of the μLED.

In some embodiments, the pixel drive circuit further includes a capacitor configured to store a value of the demura compensation. In other embodiments, the pixel drive circuit further includes a transistor to store the value of the demura compensation. In yet other embodiments, the pixel drive circuit further includes a dual gate transistor to store a pixel value and the value of the demura compensation.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a graph illustrating light emission from a μLED device as a function of current in accordance with some embodiments.

FIG. 2 is a circuit diagram of a pixel drive circuit for a μLED device.

FIG. 3 is a circuit diagram of a pixel drive circuit for a μLED device including a voltage buffer.

FIG. 4 is a circuit diagram of a pixel drive circuit for a μLED device including a drive transistor having a gate terminal configured to control a gate voltage of the drive transistor to adjust an amplitude and a pulse width of a current supplied to a μLED device in accordance with some embodiments.

FIG. 5 is graph illustrating pulse width timing for the pixel drive circuit of FIG. 4 in accordance with some embodiments.

FIG. 6 is a graph illustrating pulse width timing for a display panel of pixel drive circuits in accordance with some embodiments.

FIG. 7 is a circuit diagram for a pixel drive circuit for a μLED device in which a gate terminal of a drive transistor is configured to perform a demura compensation in accordance with some embodiments.

FIG. 8 is a graph illustrating light emission from a pixel drive circuit of FIG. 7 as a function of current in accordance with some embodiments.

FIG. 9 is a circuit diagram for a pixel drive circuit of FIG. 7 further including a demura capacitor to store demura compensation data at a display panel in accordance with some embodiments.

FIG. 10 is a circuit diagram for a pixel drive circuit including a demura capacitor to store demura compensation data at the display panel in accordance with some embodiments.

FIG. 11 is a graph illustrating a simulation of the output current as a function of the stored capacitor voltage in accordance with some embodiments.

FIG. 12 is a circuit diagram for a pixel drive circuit configured to store demura compensation data at the display panel in accordance with some embodiments.

### DETAILED DESCRIPTION

A demura calibration process adds significant overhead in (i) calibration time where each pixel has to be measured individually, (ii) storage, since each pixel's gain and offset values need to be stored, (iii) motion-to-photon delay since adjusting the data “on-the-fly” requires calculations using “full adders” and “multipliers” in the display pipeline that use additional clock cycles and finally (iv) power since all these calculations are computations that a system on a chip (SoC) has to do as fast as possible to minimize the “motion-to-photon” delay.

Intelligent data acquisition and algorithm schemes can minimize calibration time and storage. For example, instead of measuring all Gray Levels, only representative GLs are measured, or instead of calculating gain and offsets for each individual pixel, calculating gain and offsets in blocks. However, minimizing the overhead for motion-to-photon delay and power is not as straightforward.

Each μLED of an array is driven by a pixel circuit that applies power to the μLED. μLED pixel circuits include a body node to a drive transistor that is not present in typical backplane display processes such as thin film transistors and oxides. Some embodiments described herein illustrate techniques for accessing the body node of the drive transistor of the μLED pixel circuit and modifying the current through the drive transistor to perform demura compensation either at the individual pixel level or at a block level.

Historically in display technologies, the most common way of driving active-matrix arrays is a two-transistor/one capacitor (2T1C) circuit proposed by Brody et al. The 2T1C circuit has been used in both liquid crystal display (LCD) and organic light emitting diode (OLED) displays due to their operation using an amplitude modulation (AM) driving principle, in which the light output of the arrangement is analogous to the amplitude of the modulating signal provided by either a voltage applied across an LCD element or a current source inside the pixel structure in the case of emissive displays.

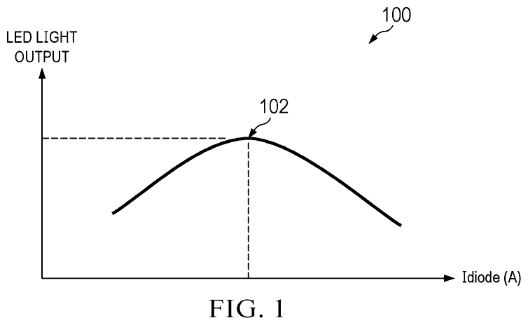

μLED devices, on the other hand, are emissive and do not benefit from the AM driving principle because the efficiency of μLED emissive devices changes across different current amplitudes. For example, FIG. 1 is a graph 100 illustrating light emission 102 from a micro-LED device as a function of current in accordance with some embodiments. As shown in FIG. 1, light emission 102 typically declines as the diode current amplitude moves away from the amplitude where the μLED shows peak efficiency.

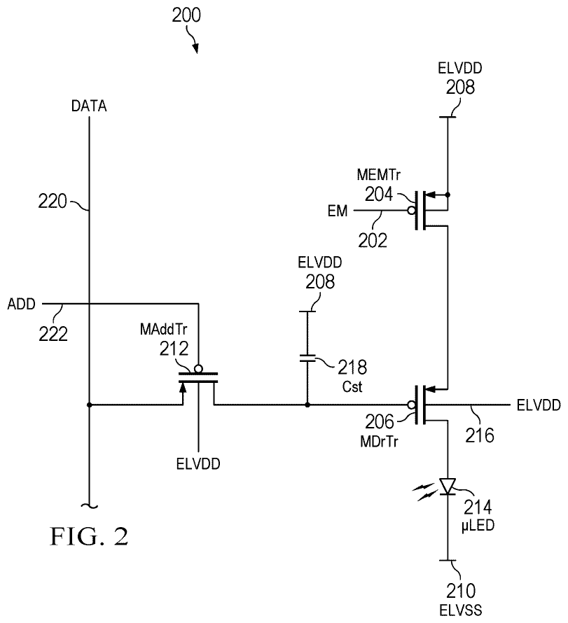

In addition, unlike liquid crystal displays that maintain a level of an applied charge until a new charge is applied, a μLED requires supply of a continuous charge over time to continue emitting light. To allow the μLED to operate at peak currents, the pulse width modulation (PWM) principle is used to drive μLED displays such that the light output of the μLED depends on the amount of time the μLED carries the modulated current. The longer the current flows into the μLED, the higher the light output is and the pixel structure appears brighter. Typically, this level of PWM control is implemented by adding an extra transistor to the standard 2T1C pixel circuit, making it a three-transistor/one capacitor (3T1C) pixel circuit like the example shown in FIG. 2.

FIG. 2 illustrates a schematic drawing of an example of a pixel drive circuit 200 for a μLED device 214. The pixel drive circuit 200 includes address transistor MAddTr 212, emission transistor MEMTr 204, and drive transistor MDrTr 206, storage capacitor Cst, and μLED device 214. The address transistor MAddTr 212 includes a source electrode connected to receive a signal 220, designated “DATA”, a drain electrode, and a control electrode connected to receive a signal 222, designated “ADD”. The address transistor MAddTr 212 further includes a body connected to a voltage reference 208 designated ELVDD. The storage capacitor Cst 218 includes a first terminal connected to the ELVDD voltage reference 208 and a second terminal connected to the drain terminal of the transistor 212.

The emission transistor MEMTr 204 includes a source electrode connected to the ELVDD voltage reference 208, a drain electrode, and a gate electrode connected to receive EM signal 202. The drive transistor MDrTr 206 includes a source electrode connected to the drain electrode of the emission transistor MEMTr 204, a drain electrode, a body node 216 connected to the ELVDD voltage reference 208, and a gate electrode connected to the drain electrode of the address transistor MAddTr 212. The μLED device 214 includes a terminal connected to the drain electrode of the drive transistor MDrTr 206 and an electrode connected to a voltage reference 210, designated ELVSS.

Both the address transistor MAddTr 212 and emission transistor MEMTr 204 act as switches such that when the ADD line 222 is low, the address transistor MAddTr 212 is open and when the EM line 202 is low, the emission transistor MEMTr 204 is open. The address transistor MAddTr 212 addresses the storage capacitor Cst 218. The drive transistor MDrTr 206 acts as a current source to a μLED device 214 and is turned on or off depending on the address transistor MAddTr 212 being closed and is driven by a bit line DATA 220.

The gate terminal of the address transistor MAddTr 212 is at the ADD line 222, which turns the address transistor MAddTr 212 on and off and supplies logic signals between logic 0 and logic 1, which ranges from 0V for logic 0 and 5V (or the difference between ELVDD 208 and ELVSS 210) for logic 1. The address transistor MAddTr 212 takes analog voltage data from the DATA line 220 when the address transistor MAddTr 212 is enabled (i.e., closed) and transfers the analog voltage data to be stored at the storage capacitor Cst 218. Once the analog voltage data is stored at the storage capacitor Cst 218, the address transistor MAddTr 212 disengages by becoming an open switch.

The analog voltage data stored at the storage capacitor Cst 218 becomes a known gate voltage input to the drive transistor MDrTr 206. The current through the drive transistor MDrTr 206 is analogous to the analog voltage data stored at the storage capacitor Cst 218 and modulates the amplitude of the pixel current at the μLED device 214. The pulse width of the pixel current at the μLED device 214 is a function of the EM line 202. The amplitude of the pixel current may be modulated by controlling DATA line 220 and the pulse width of the pixel current is modulated by controlling the EM line 202 by varying the pulse width or percentage of time that the current pulse is turned on.

μLEDs operate at voltages as high as 3V, while the constant current source (CCS) called MDrTr 206 and the emission transistor MEMTr 204 require overhead ranges typically from 0.5V-1V. To also budget for temperature effects and IR drops (voltage drops due to energy losses in a resistor), another 0.5V-1V should be considered. Accordingly, the total rail-to-rail voltage headroom ELVDD 208−ELVSS 210=5V in typical operation.

All the transistor devices inside the pixel drive circuit must operate within this range of voltages, which is typically achieved during wafer processing by including a mask that outlines areas on the wafer with low density doping (LDD) in the transistors' source and drain terminals. To enable the use of such masks, large “keep-out” areas around the LDD mask boundaries inside the pixel drive circuit are accounted for in the layout process, effectively increasing the minimum device size available by a factor of 25×-100× depending on the tech node. For panel designs used in AR applications this should be avoided because it limits the minimum pixel pitch and hence the density of μLED arrays.

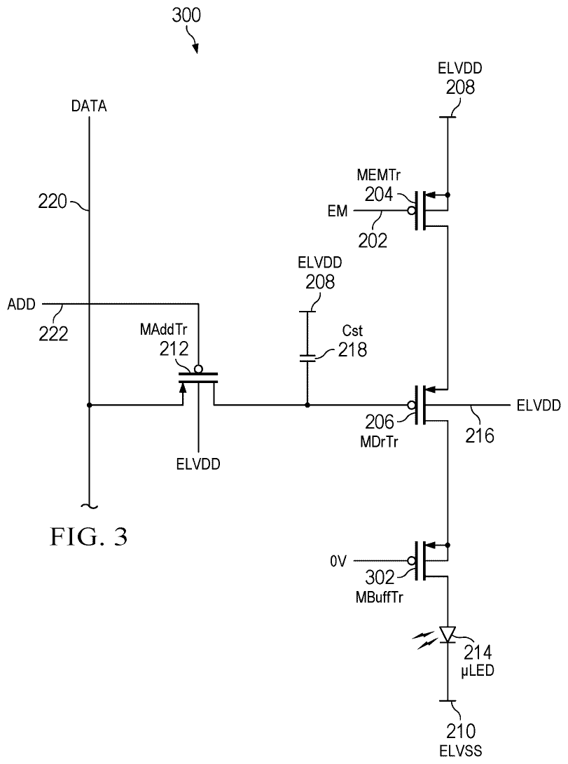

To remedy this issue and allow for a smaller minimum pixel pitch, a medium-voltage device MBuffTr that acts as a voltage buffer can decouple the 3V required across the LEDs from the rest of the pixel circuit, as shown in FIG. 3. FIG. 3 is a circuit diagram of a pixel drive circuit 300 for the μLED device 214 including a voltage buffer transistor MBuffTr 302.

The pixel drive circuit 300 includes address transistor MAddTr 212, emission transistor MEMTr 204, and drive transistor MDrTr 206, storage capacitor Cst 218, voltage buffer transistor MBuffTr 302, and μLED device 214. The address transistor MAddTr 212 includes a source electrode connected to receive the DATA signal 220, a drain electrode, and a control electrode connected to receive the ADD signal 222. The address transistor MAddTr 212 further includes a body connected to a voltage reference 208 designated ELVDD. The storage capacitor Cst 218 includes a first terminal connected to the ELVDD voltage reference 208 and a second terminal connected to the drain terminal of the transistor 212.

The emission transistor MEMTr 204 includes a source electrode connected to the ELVDD voltage reference 208, a drain electrode, and a gate electrode connected to receive the EM signal 202. The drive transistor MDrTr 206 includes a source electrode connected to the drain electrode of the emission transistor MEMTr 204, a drain electrode, a body connected to the ELVDD voltage reference 208, and a gate electrode connected to the drain electrode of the address transistor MAddTr 212. The voltage buffer transistor MBuffTr 302 includes a source electrode connected to the drain electrode of the drive transistor MDrTr 206, a drain electrode, a body connected to the drain electrode of the drive transistor MDrTr 206, and a gate electrode connected to ground. The μLED device 214 includes a terminal connected to the drain electrode of the voltage buffer transistor MBuffTr 302 and an electrode connected to the ELVSS voltage reference 210.

The voltage buffer transistor MBuffTr 302 is an extra PMOS buffer transistor in its own NWell that has been added along with a 0V line per pixel circuit to the pixel drive circuit 200 in the illustrated example of FIG. 3. In the illustrated example, the ELVDD rail 208 can now be kept at 1.2V and the address transistor MAddTr 212, the emission transistor MEMTr 204 and the drive transistor MDrTr 206 are low voltage devices that do not require the LDD doping since the voltages applied to them will never be higher than the difference between 0V and the voltage of the ELVDD rail 208 (i.e., 1.2V in the current example) due to the circuit topology. However, the size of the extra transistor and line area consumed are balanced out by the amount by which the address transistor MAddTr 212, the emission transistor MEMTr 204 and the drive transistor MDrTr 206 have shrunk. This not only provides area savings in the pixel drive circuit 300 but also dramatically reduces the total power consumed by the electronics (>10× and maybe up to 20× depending on the data dynamic range) since both the DATA line and EM line voltage swings do not have to be operated at the 3V and 5V but rather 0.5V and 1.2V, respectively.

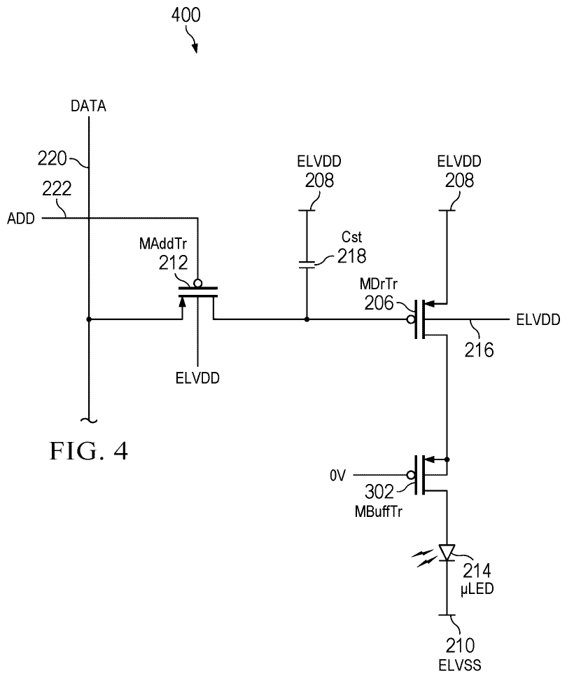

The pixel area can further be reduced by removing the MEMTr transistor, as shown in FIG. 4. FIG. 4 is a circuit diagram of a pixel drive circuit 400 for a μLED device 214 including a drive transistor MDrTr 206 having a gate terminal (also referred to herein as a body node) configured to control a gate voltage of the drive transistor MDrTr 206 to adjust an amplitude and a pulse width of a current supplied to the μLED device 214 in accordance with some embodiments.

The pixel drive circuit 400 includes address transistor MAddTr 212, drive transistor MDrTr 206, voltage buffer transistor MBuffTr 302, storage capacitor Cst 218, and μLED device 214. The address transistor MAddTr 212 includes a source electrode connected to receive the DATA signal 220, a drain electrode, and a control electrode connected to receive ADD signal 222. The address transistor MAddTr 212 further includes a body connected to the ELVDD voltage reference 208. The storage capacitor Cst 218 includes a first terminal connected to the ELVDD voltage reference 208 and a second terminal connected to the drain terminal of the address transistor MAddTr 212.

The drive transistor MDrTr 206 includes a source electrode connected to the ELVDD voltage reference 208, a drain electrode, a body connected to the ELVDD voltage reference 208, and a gate electrode connected to the drain electrode of the address transistor MAddTr 212. The voltage buffer transistor MBuffTr 302 includes a source electrode connected to the drain electrode of the drive transistor MDrTr 206, a drain electrode, a body connected to the drain electrode of the drive transistor MDrTr 206, and a gate electrode connected to ground. The μLED device 214 includes a terminal connected to the drain electrode of the drive transistor MDrTr 206 and an electrode connected to the ELVSS voltage reference 210.

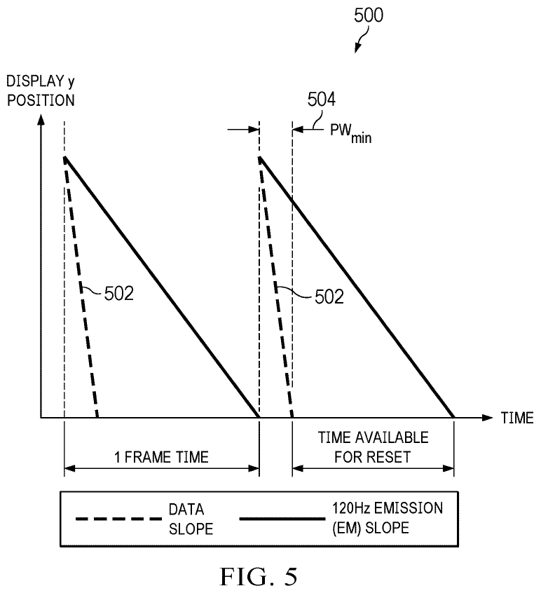

In the illustrated example, the PWM function of the emission transistor MEMTr 204 is absorbed into the drive transistor MDrTr 206. This is achieved by changing a data slope from following a rolling shutter 120 Hz emission slope to a data slope that is dictated by the total time required to program the data into the “worst-case parasitics” row for every physical row inside the panel and using the extra time to reset the programmed data to logic 0 in a serial manner to enable PWM. An exaggerated example of such an approach is shown in FIG. 5, which is graph 500 illustrating pulse width timing for the pixel drive circuit 400 of FIG. 4 in accordance with some embodiments.

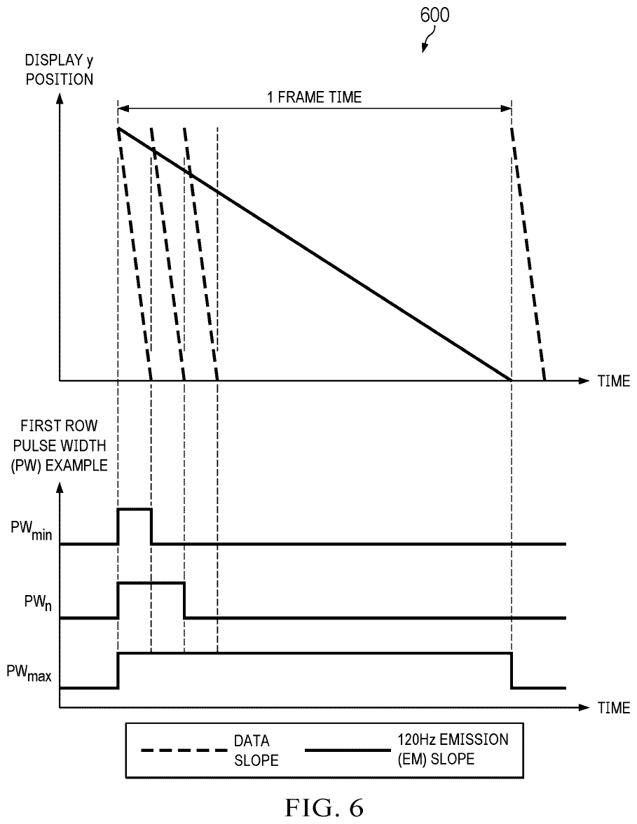

In the illustrated example, the slope of the data line 502 (rows programmed per second) multiplied by the total number of rows determines the minimum pulse width PWₘᵢₙ 504 that can be programmed in the panel. Additionally, the pixel can be reset by setting the data line 502 to logic 0 using the rest of the time available, which can occur in a serial manner by continually addressing the panel as shown in FIG. 6.

FIG. 6 is a graph illustrating pulse width timing for a display panel of pixel drive circuits in accordance with some embodiments. The PWₘᵢₙ is given as

$${PW}_{min} = {T}_{worstCaseRow} \cdot {N}_{rows}$$

and depends on the number of rows that exist in a panel. The larger the number of rows, the longer the PWₘᵢₙ gets, which restricts the total dynamic range (DR) in a higher resolution panel. This is not a problem for augmented reality (AR) displays since the maximum resolution is bound by tradeoffs between the optical stack, field of view (FOV) and the human eye's inability to resolve content lower than 60 pixels per degree (PPD). It is possible, however, that AR displays will exceed resolutions of 2K, at which point the total PWM dynamic range can be complemented by the current control capability of such a driving approach since it has pixel level granularity.

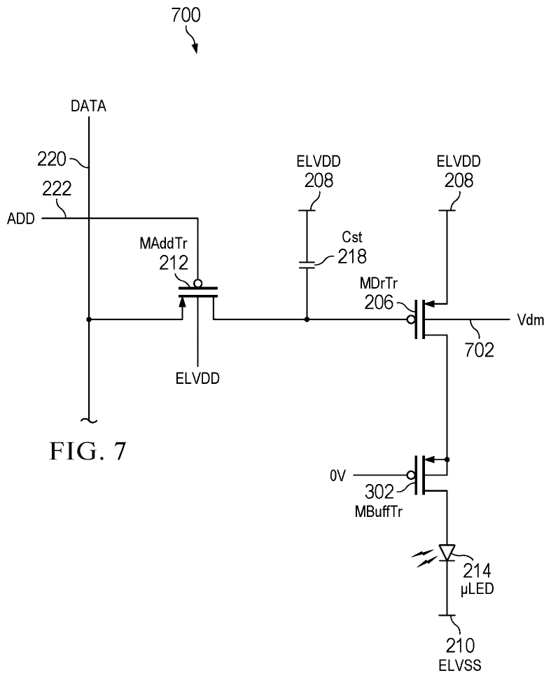

To facilitate demura compensation while saving power, memory, and dynamic range, in some embodiments the body node of the drive transistor of the μLED pixel circuit is used to modify the current through the drive transistor to apply a demura compensation value. FIG. 7 is a circuit diagram for a pixel drive circuit 700 for μLED device 214 in which a gate terminal of the drive transistor MDrTr 206 is configured to perform a demura compensation in accordance with some embodiments.

The pixel drive circuit 700 includes address transistor MAddTr 212, drive transistor MDrTr 206, voltage buffer transistor MBuffTr 302, storage capacitor Cst 218, and a μLED device 214. The address transistor MAddTr 212 includes a source electrode connected to receive DATA signal 220, a drain electrode, and a control electrode connected to receive ADD signal 222. The address transistor MAddTr 212 further includes a body connected to the ELVDD voltage reference 208. The storage capacitor Cst 218 includes a first terminal connected to the ELVDD voltage reference 208 and a second terminal connected to the drain terminal of the address transistor MAddTr 212.

The drive transistor MDrTr 206 includes a source electrode connected to the ELVDD voltage reference 208, a drain electrode, a body node Vdm 702 connected to a demura compensation voltage, and a gate electrode connected to the drain electrode of the address transistor MAddTr 212. The voltage buffer transistor MBuffTr 302 includes a source electrode connected to the drain electrode of the drive transistor MDrTr 206, a drain electrode, a body connected to the drain electrode of the drive transistor MDrTr 206, and a gate electrode connected to ground. The μLED device 214 includes a terminal connected to the drain electrode of the drive transistor MDrTr 206 and an electrode connected to the ELVSS voltage reference 210.

The body node Vdm 702 of the drive transistor MDrTr 206 is a node that is available for external control. The body node Vdm 702 is specific to μLEDs and does not exist in typical backplane display processes such as thin film transistors (TFTs) and oxides, because the TFTs' channels in these processes are formed on their own conductive thin films that are electrically isolated from one another. Because AR displays are small enough for the backplane to be integrated in its own bulk silicon die without significant cost impact, the body node Vdm 702 is used to perform a demura compensation in some embodiments.

Each of the address transistor MAddTr 212, drive transistor MdrTr 206, and voltage buffer transistor MBuffTr 302 of FIG. 7 have the same polarity. The address transistor MAddTr 212 is used as a switch for which the address (ADD) signal 222 turns the address transistor MAddTr 212 on and off. The address is supplied with logic signals of logic 0 and logic 1, where logic zero is 0V and logic 1 is 5V in some embodiments. In some embodiments, the range of voltage for the address is between ELVDD and ELVSS. When the address transistor MAddTr 212 is acting as a closed switch, the address transistor MAddTr 212 takes data from the analog voltage DATA signal 220 and transfers the data to the storage capacitor Cst 218.

Conventionally, the gains and offsets used to compensate for non-uniformities for each pixel are calculated through the demura calibration process and are added to the DATA signal. However, adding the gains and offsets to the DATA signal 220 reduces the dynamic range of the data that can be applied to the μLED device 214, because at least one bit of the DATA signal 220 is used for the gains and offsets of the demura compensation. In some embodiments, a demura compensation value is applied to the body node Vdm 702 based on at least one of a temperature of the pixel drive circuit 700 and a desired brightness of the μLED device 214.

Once the data is stored at the storage capacitor Cst 218, the address transistor MAddTr 212 disengages by setting its gate to logic 0, such that the address transistor MAddTr 212 becomes an open switch. During the time the storage capacitor Cst 218 maintains the charge, the voltage across the storage capacitor Cst 218 is fixed. Because the potential across the storage capacitor Cst 218 is known, the current through the drive transistor MdrTr 206 is also known, since the storage capacitor Cst 218 is applied at the drive transistor MdrTr 206's gate terminal. Because the current through the drive transistor MdrTr 206 is constant and known, the drive transistor MdrTr 206 acts as a current source rather than a switch. The gate voltage of the drive transistor MdrTr 206 can be controlled to change the amplitude of the current through the drive transistor MdrTr 206 that goes to the μLED device 214.

The voltage buffer transistor MBuffTr 302 acts as a buffer for which the source never drops below the gate voltage, which is 0V, even if the drain voltage ELVSS 210 drops below 0V. As a result, the circuitry above the voltage buffer transistor MBuffTr 302 operates between voltages of 0V and the ELVDD voltage 208, which is 1.2-1.5V in some embodiments. The lower voltage range eliminates the need for LDD mask boundaries inside the pixel drive circuit, and thus reduces the minimum size of the pixel drive circuit, allowing for denser μLED arrays.

The physical mechanisms of how the body-to-source voltage affects the current through a transistor can be used to change the threshold voltage of the device, as shown below:

$${V}_{T} = {V}_{T 0} + γ ( \sqrt{\vert - 2 {Φ}_{p} + {V}_{SB} \vert} - \sqrt{\vert - 2 {Φ}_{p} \vert} )$$

$$where$$

$$γ = - \frac{\sqrt{2 q {N}_{A} {ε}_{Si} .}}{{C}_{ox}}$$

and the (−) in γ since a PMOS transistor is used for this analysis. By controlling the threshold voltage of the device, the current through the drive transistor MdrTr 206 can be trimmed either on each individual pixel level or at the block level to enable demura compensation. Applying demura compensation via the drive transistor MdrTr 206 saves power that would otherwise be used to perform calculations to determine and apply the demura compensation values to the data signal and improves latency while also expanding the dynamic range of the data (because the DATA signal 220 does not also need to include the demura compensation value). In addition, the demura compensation data can be stored locally at the display panel (e.g., at a capacitor) instead of being stored at a frame buffer external to the display panel.

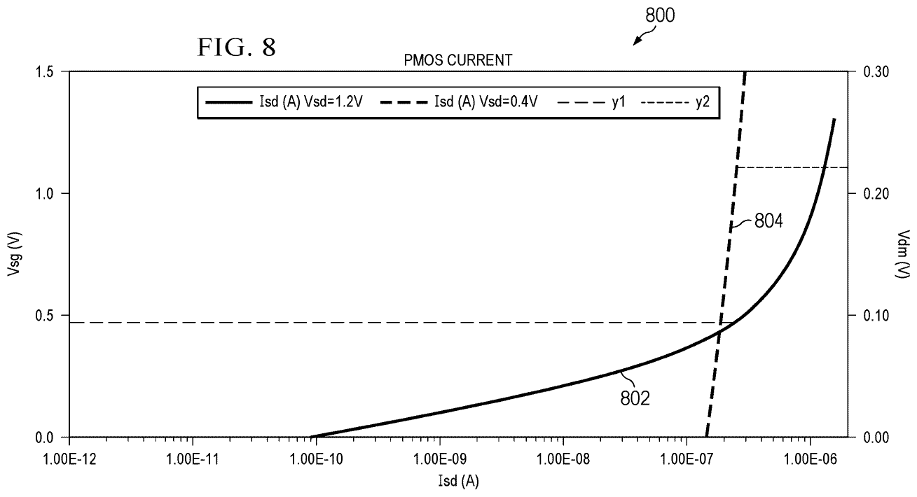

FIG. 8 shows an example simulation of a generic 22 nm node. The curve 802 is a sweep of the data voltage between the source and gate (Vsg) of the drive transistor MDrTr 206 (left y-axis) vs. the source-to-drain (Isd) device current (x-axis) while keeping the body node Vdm 702 at the same potential as the source. Once the desired gate voltage is found that makes the drive transistor MDrTr 206 carry the desired current (250 nA in this case) the Vsg gate voltage is fixed to that level (0.48V). The curve 804 shows how the current of the drive transistor MDrTr 206 varies (x-axis) while sweeping the body node Vdm 702, which effectively changes the body-to-source Vsb voltage of the drive transistor (right y-axis).

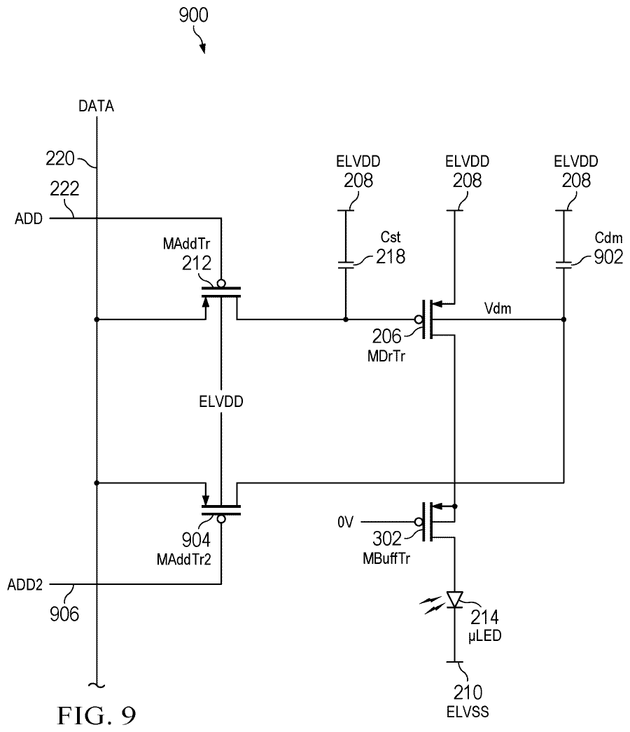

As illustrated, a 0-300 mV change in the body node Vdm 702 voltage can vary the total current by almost double. Since output light of emissive devices is proportional to the driven current, a 200% variation should be sufficient enough to cover display variations in luminance of up to 200%. The only limitation is that changing the body node Vdm 702's potential by a large amount will introduce current to the substrate of the drive transistor MDrTr 206 that can lead to potential noise issues. Therefore, in some embodiments only small voltage values are used if possible. One implementation of such a circuit would be to attach a capacitor directly to the body terminal of the drive transistor MDrTr 206 and use a switch to program that capacitor via the same data line. An example of this topology is shown in FIG. 9.

FIG. 9 is a circuit diagram for a pixel drive circuit 900 similar to the pixel drive circuit 700 of FIG. 7 and further including a demura capacitor Cdm 902 to store demura compensation data at a display panel in accordance with some embodiments. The pixel drive circuit 900 includes address transistor MAddTr 212, a second address transistor MAddTr2 904, drive transistor MDrTr 206, voltage buffer transistor MBuffTr 302, storage capacitor Cst 218, and μLED device 214. The address transistor MAddTr 212 includes a source electrode connected to receive DATA signal 220, a drain electrode, and a control electrode connected to receive ADD signal 222. The address transistor MAddTr 212 further includes a body connected to the ELVDD voltage reference 208. The second address transistor MAddTr2 904 includes a source electrode connected to receive DATA signal 220, a drain electrode, and a control electrode connected to receive ADD2 signal 906. In some embodiments, the second address transistor MAddTr2 904 includes a source electrode connected to receive a demura compensation signal Vdm, a drain electrode, and a control electrode connected to receive the ADD2 signal 906. The second address transistor MAddTr2 904 further includes a body connected to the ELVDD voltage reference 208. The storage capacitor Cst 218 includes a first terminal connected to the ELVDD voltage reference 208 and a second terminal connected to the drain terminal of the address transistor MAddTr 212.

The drive transistor MDrTr 206 includes a source electrode connected to the ELVDD voltage reference 208, a drain electrode, a body node 702 connected to receive the demura compensation signal Vdm, and a gate electrode connected to the drain electrode of the address transistor MAddTr 212. The demura capacitor Cdm 902 includes a first terminal connected to the ELVDD voltage reference 208 and a second terminal connected to the drain terminal of the second address transistor MAddTr2 904. The voltage buffer transistor MBuffTr 302 includes a source electrode connected to the drain electrode of the drive transistor MDrTr 206, a drain electrode, a body connected to the drain electrode of the drive transistor MDrTr 206, and a gate electrode connected to ground. The μLED device 214 includes a terminal connected to the drain electrode of the voltage buffer transistor MBuffTr 302 and an electrode connected to the ELVSS voltage reference 210.

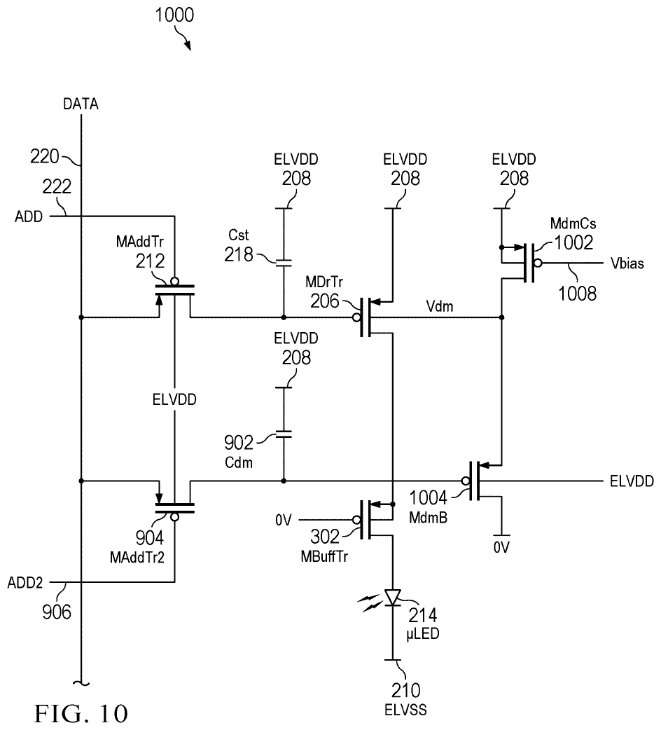

In the illustrated example, a demura capacitor Cdm 902 stores demura compensation data at the display panel, while the second address line ADD2 906 transmits a location where the demura compensation data is stored. In some instances, the small technology node can cause the circuit to leak and limit the size available for the demura capacitor Cdm 902. The body-to-source connection of a PMOS transistor is a reverse-biased PN junction which can be leaky (almost 10 nA) for tech nodes smaller than 22 nm. To make such a topology more stable and controllable, the capacitor has to be large so that it does not discharge too quickly. Another variant of such an implementation is shown in FIG. 10.

FIG. 10 is a circuit diagram for a pixel drive circuit 1000 including a demura capacitor Cdm 902 to store demura compensation data at the display panel in accordance with some embodiments. The pixel drive circuit 1000 includes address transistor MAddTr 212, second address transistor MAddTr2 904, drive transistor MDrTr 206, voltage buffer transistor MBuffTr 302, demura current source transistor MdmCS 1002, bias demura transistor MdmB 1004, storage capacitor Cst 218, demura capacitor Cdm 902, and μLED device 214.

The address transistor MAddTr 212 includes a source electrode connected to receive DATA signal 220, a drain electrode, and a control electrode connected to receive ADD signal 222. The address transistor MAddTr 212 further includes a body connected to the ELVDD voltage reference 208. The second address transistor MAddTr2 904 includes a source electrode connected to receive DATA signal 220, a drain electrode, and a control electrode connected to receive ADD2 signal 906. In some embodiments, the second address transistor MAddTr2 904 includes a source electrode connected to the gate electrode of the bias demura transistor MdmB 1004, a drain electrode, and a control electrode connected to receive the ADD2 signal 906. The storage capacitor Cst 218 includes a first terminal connected to the ELVDD voltage reference 208 and a second terminal connected to the drain terminal of the address transistor MAddTr 212.

The drive transistor MDrTr 206 includes a source electrode connected to the ELVDD voltage reference 208, a drain electrode, a body node Vdm 702 connected to a demura compensation voltage, and a gate electrode connected to the drain electrode of the address transistor MAddTr 212. The demura capacitor Cdm 902 includes a first terminal connected to the ELVDD voltage reference 208 and a second terminal connected to the drain terminal of the second address transistor MAddTr2 904. The demura current source transistor MdmCS 1002 includes a source electrode connected to the ELVDD voltage reference 208, a drain electrode, a body connected to the ELVDD voltage reference 208, and a gate electrode commented to a bias voltage Vbias 1008. The bias demura transistor MdmB 1004 includes a source electrode connected to the drain of the demura current source transistor MdmCS 1002, a drain electrode connected to ground, a body connected to the ELVDD voltage reference 208, and a gate electrode connected to the drain of the second address transistor MAddTr2 904.

The voltage buffer transistor MBuffTr 302 includes a source electrode connected to the drain electrode of the drive transistor MDrTr 206, a drain electrode, a body connected to the drain electrode of the drive transistor MDrTr 206, and a gate electrode connected to ground. The μLED device 214 includes a terminal connected to the drain electrode of the voltage buffer transistor MBuffTr 302 and an electrode connected to the ELVSS voltage reference 210.

In the illustrated embodiment, three transistors (demura current source transistor MdmCS 1002, bias demura transistor MdmB 1004, and second address transistor MAddTr2 1006) are used in conjunction with the demura capacitor Cdm 902 and an extra two lines (second address line ADD2 906 and bias voltage Vbias 1008). In the illustrated example, the Vbias node is a global voltage that makes the demura current source transistor MdmCS 1002 act as a current source. The second address transistor MAddTr2 1006 is a switch that isolates the charge stored in the demura capacitor Cdm 902 from the DATA line 220. The second address transistor MAddTr2 1006 also enables the usage of just one data line to store both the GL value data as well as the demura data. The voltage across the demura capacitor Cdm 902 is approximately a threshold voltage “Vthp” below what the desired voltage the body of the drive transistor MDrTr 206 requires for demura, or V_{Cdm}=Vdm+Vthp. In some embodiments, programming the demura capacitor Cdm 902 occurs during the time the display is off to avoid “screen tearing” and other front of screen side effects and conflicts with programming the displayed data. Finally, the two new lines added to the pixel circuit can be sized using the minimum rules since they will not carry any significant currents.

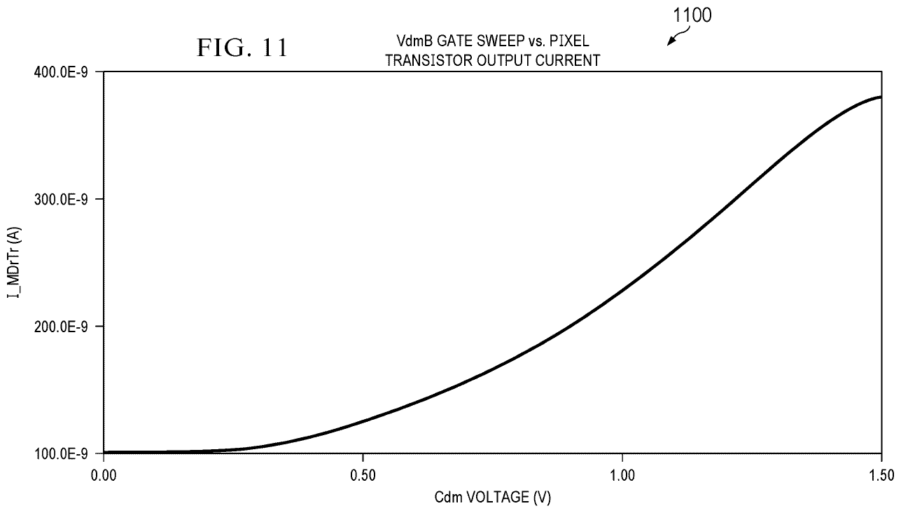

FIG. 11 is a graph 1100 illustrating a simulation of the output current DrTr as a function of the stored voltage of the demura capacitor Cdm 902 in accordance with some embodiments. Using such an approach helps decouple the dynamic range overhead required for demura compensation. For example, the data dynamic range is not diminished to adjust the current or pulse width applied at the drive transistor MDrTr 206 for demura compensation because such control can be applied to the circuit via the source-to-body potential. However, extra area is required by the circuit topology.

In some embodiments, to further minimize the area of the Cdm storage capacitor, the demura current source transistor MdmCS 1002, bias demura transistor MdmB 1004 and drive transistor MDrTr 206 are replaced by a dual gate transistor MDrTr 1202, similar to the dual gate transistors used by non-volatile memories (NVMs). Replacing the demura current source transistor MdmCS 1002, bias demura transistor MdmB 1004 and drive transistor MDrTr 206 with the dual gate transistor MDrTr 1202 in conjunction with the second address transistor MAddTr2 1006 provides the same control of the device's Vth. In this way, the voltage potential of the second gate does not need to be kept constant because the charge responsible for that potential is stored locally inside the second MDrTr gate electrode.

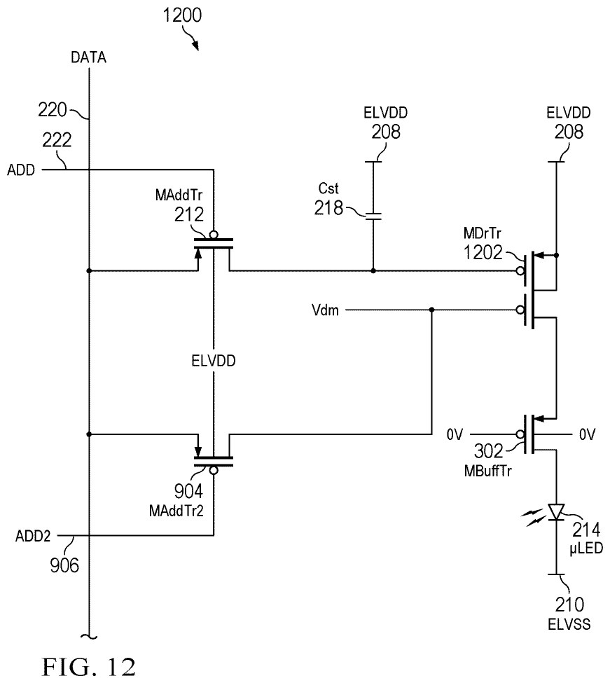

FIG. 12 is a circuit diagram for a pixel drive circuit 1200 to store demura compensation data at the display panel in accordance with some embodiments. The pixel drive circuit 1200 includes address transistor MAddTr 212, second address transistor MAddTr2 904, voltage buffer transistor MBuffTr 302, dual gate transistor MDrTr 1202, storage capacitor Cst 218, and μLED device 214. The address transistor MAddTr 212 includes a source electrode connected to receive DATA signal 220, a drain electrode, and a control electrode connected to receive ADD signal 222. The address transistor MAddTr 212 further includes a body connected to the ELVDD voltage reference 208. The second address transistor MAddTr2 904 includes a source electrode connected to receive DATA signal 220, a drain electrode, and a control electrode connected to receive ADD2 signal 906. The storage capacitor Cst 218 includes a first terminal connected to the ELVDD voltage reference 208 and a second terminal connected to the drain terminal of the address transistor MAddTr 212.

The dual gate transistor MDrTr 1202 includes a source electrode connected to the ELVDD voltage reference 208, a drain electrode, a body node connected to the ELVDD voltage reference 208, and a first gate electrode connected to the drain electrode of the address transistor MAddTr 212, and a second gate electrode connected to the drain electrode of the second address transistor MAddTr2 904 and the demura voltage Vdm.

The voltage buffer transistor MBuffTr 302 includes a source electrode connected to the drain electrode of the dual gate transistor MDrTr 1202, a drain electrode, a body connected to ground, and a gate electrode connected to ground. The μLED device 214 includes a terminal connected to the drain electrode of the voltage buffer transistor MBuffTr 302 and an electrode connected to the ELVSS voltage reference 210.

In the illustrated example, the peripheral circuitry, extra lines and demura capacitor Cdm 902 of the embodiment illustrated in FIG. 10 are removed with the exception of the second address transistor MAddTr2 1006, which still uses the same DATA line 220 to set the floating gate voltage of the dual gate transistor MDrTr 1202. The floating gate Vdm also acts as the local storage element to enable the same functionality as the previous circuit topology but with fewer elements inside the pixel drive circuit.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
controlling a gate terminal of a drive transistor of a pixel drive circuit of a micro-light emitting diode (μLED) of a display to modulate an amplitude and a pulse width of a current supplied to the μLED by the pixel drive circuit.

2. The method of claim 1, wherein controlling the gate terminal comprises applying a demura compensation to adjust an amount of light emitted by the μLED.

3. The method of claim 2, wherein a value of the demura compensation is based on at least one of a temperature of the pixel drive circuit and a desired brightness of the μLED.

4. The method of claim 2, further comprising storing a value of the demura compensation at a capacitor of the pixel drive circuit.

5. The method of claim 2, further comprising storing a value of the demura compensation at a transistor of the pixel drive circuit.

6. The method of claim 2, further comprising storing a pixel value and a value of the demura compensation at a dual gate transistor of the pixel drive circuit.

7. The method of claim 4, wherein storing the value of the demura compensation is performed while the display is off.

8. A pixel drive circuit comprising:
a drive transistor including a gate terminal configured to control a gate voltage of the drive transistor to adjust an amplitude and a pulse width of a current supplied to a micro-LED (μLED) of a display.

9. The pixel drive circuit of claim 8, wherein the drive transistor is configured to apply a demura compensation to adjust an amount of light emitted by the μLED.

10. The pixel drive circuit of claim 9, wherein a value of the demura compensation is based on at least one of a temperature of the pixel drive circuit and a desired brightness of the μLED.

11. The pixel drive circuit of claim 9, further comprising a capacitor configured to store a value of the demura compensation.

12. The pixel drive circuit of claim 9, further comprising a transistor configured to store a value of the demura compensation.

13. The pixel drive circuit of claim 9, further comprising a dual gate transistor configured to store a pixel value and a value of the demura compensation.

14. The pixel drive circuit of claim 11, wherein the value of the demura compensation is stored while the display is off.

15. A display comprising:
an array of micro-LEDs (μLEDs); and
a pixel drive circuit configured to drive each μLED of the array, each pixel drive circuit comprising:
a drive transistor including a gate terminal configured to control a gate voltage of the drive transistor to adjust an amplitude and a pulse width of a current supplied to the μLED.

16. The display of claim 15, wherein the drive transistor is configured to apply a demura compensation to adjust an amount of light emitted by the μLED.

17. The display of claim 16, wherein a value of the demura compensation is based on at least one of a temperature of the pixel drive circuit and a desired brightness of the μLED.

18. The display of claim 16, wherein the pixel drive circuit further comprises a capacitor configured to store a value of the demura compensation.

19. The display of claim 16, wherein the pixel drive circuit further comprises a transistor configured to store a value of the demura compensation.

20. The display of claim 16, wherein the pixel drive circuit further comprises a dual gate transistor configured to store a pixel value and a value of the demura compensation.
